(19) United States
(12) Patent Application Publication
(10) Pub. No.: US 2010/0178964 A1
(43) Pub. Date: Jul. 15, 2010

(54) Roll for a husking machine

(76) Inventor: Ronald L. Anderson, Eugene, OR (US)

Correspondence Address: James D. Givnan, Jr., 8175 S. W. Ernst Road, Portland, OR, 97225, US

(21) Appl. No.: 12/321,116

(22) Filed: Jan. 13, 2009

(51) Int. Cl. A01D 82/02

(52) U.S. Cl. 460/32

(57) ABSTRACT

A husking roll for use in a husking machine has drive plates defining an axial opening for reception of a drive shaft having flats for drive plate engagement. The drive plates may serve to carry blades for severing husks and other debris from an article. The blades have a helical component and are embedded in lands of an elastomeric cover. A mold loading device magnetically supports the drive plates during a molding operation and is subsequently, lengthwise extracted from the completed roll.

### BACKGROUND OF THE INVENTION

The present invention concerns construction of rolls for installation on a powered roll shaft of a machine of the type used to remove debris such as the husk from harvested corn.

Such machines typically include multiple pairs of powered shafts each equipped with a series of rolls having grooved surfaces, which engage and pull off the leaves or husks from ears of corn. The rolls are subjected to severe wear and long periods of continuous operation during harvesting season with roll failure being costly from repair downtime of the husking machine.

A husking machine roll typically includes a lengthwise internal metal sleeve corresponding in diameter to the powered roll shaft of the machine with each roll shaft provided with end to end mounted rolls. Prior art rolls may carry knife elements welded to the internal metal sleeve, which sever debris and any ear of corn that has raised to an upright position during passage along a pair of powered roll shafts. Such upright ears can rapidly abrade and destroy a roll resulting in costly machine downtime.

Prior art rolls with metal sleeves are driven by keyed engagement of the metal sleeve with a powered shaft of the machine.

Roll cost of manufacture is adversely affected by inclusion of the above noted metal sleeve and the knives welded thereto.

U.S. Pat. Nos. 4,278,097 and 4,625,735 are incorporated herein by reference and disclose roll members with metal sleeves that are keyed to a powered shaft of husking machine.

### SUMMARY OF THE PRESENT INVENTION

The present invention in embodied within a roll for installation in a machine for removing extraneous matter from a product. Heretofore most all roll construction entailed welding of blades or knives at points along a roll sleeve. Sleeve and knife installation thereon are significant factors in roll and shipping costs.

Present roll construction avoids costly fabrication by casting of the roll with blades embedded therein. Drive plates in the roll preferably include blades.

Transmission of torque to the present roll, from a powered shaft, is by drive means in the roll in driven contact with flats on the shaft.

### BRIEF DESCRIPTION OF DRAWINGS

In the accompanying drawings:

FIG. 1 is a perspective view of a husking roll with current improvements;

FIG. 2 is a perspective view of the present husking roll with drive components in full lines and the elastomeric cover in broken lines;

FIG. 3 is a perspective view of a drive component removed from the roll;

FIG. 3A is a sectional view taken a long line 3A-3A of FIG. 3;

FIG. 4 is a perspective view of a companion drive member removed from the roll;

FIG. 4A is a sectional view taken along line 4A-4A of FIG. 4;

FIG. 5 is a sectional view taken along line 5-5 of FIG. 2 with a roll cover and drive shaft in full lines;

FIG. 6 is a perspective view of a modified form of a drive component for a husking roll prior to an elastomeric cover;

FIG. 7 is a sectional view taken along line 7-7 of FIG. 6 with the roll cover added;

FIG. 8 is a schematic view of drive members with dashed lines denoting paths of blades carried by drive members;

FIG. 9 is a perspective view of a further modified form of the invention in place on a mold loading device;

FIG. 10 is a fragmentary perspective view of a machine drive shaft for powering a husking roll.

### DETAILED DESCRIPTION OF THE EMBODIMENTS

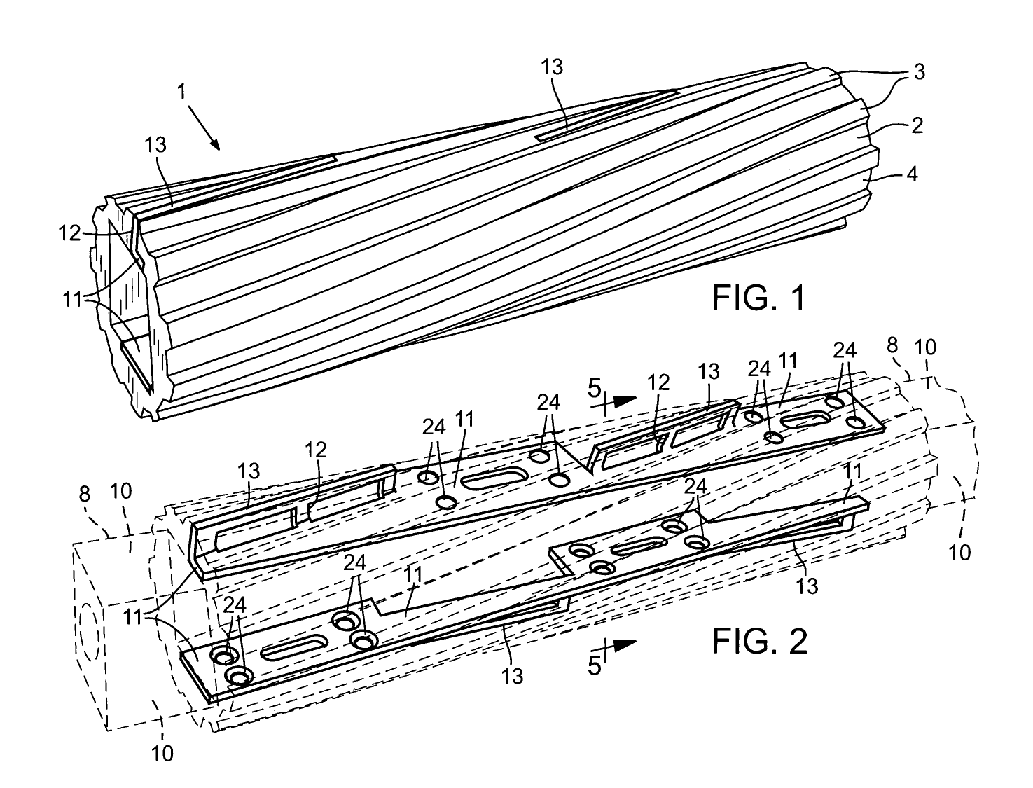

With continuing attention to the drawings FIG. 1 shows one form of the present roll generally at 1 with an elastomeric exterior or cover 2 with helical lands 3 and grooves 4.

A powered shaft at 8 has flats 10 thereon and lengthwise bore at 9. Shaft 8 may be part of a husking machine shown in the earlier noted patents incorporated herein by reference. A stub shaft is at 7 (FIG. 10).

Roll drive means at 11 are of elongate, plate configuration from which blades 12 project. An outermost or cutting blade edge is at 13. Preferably the blades are canted to permit extended length embedded within lands 3. In some husking operations, the roll elastomer may be of adequate hardness to permit dispensing with the blades.

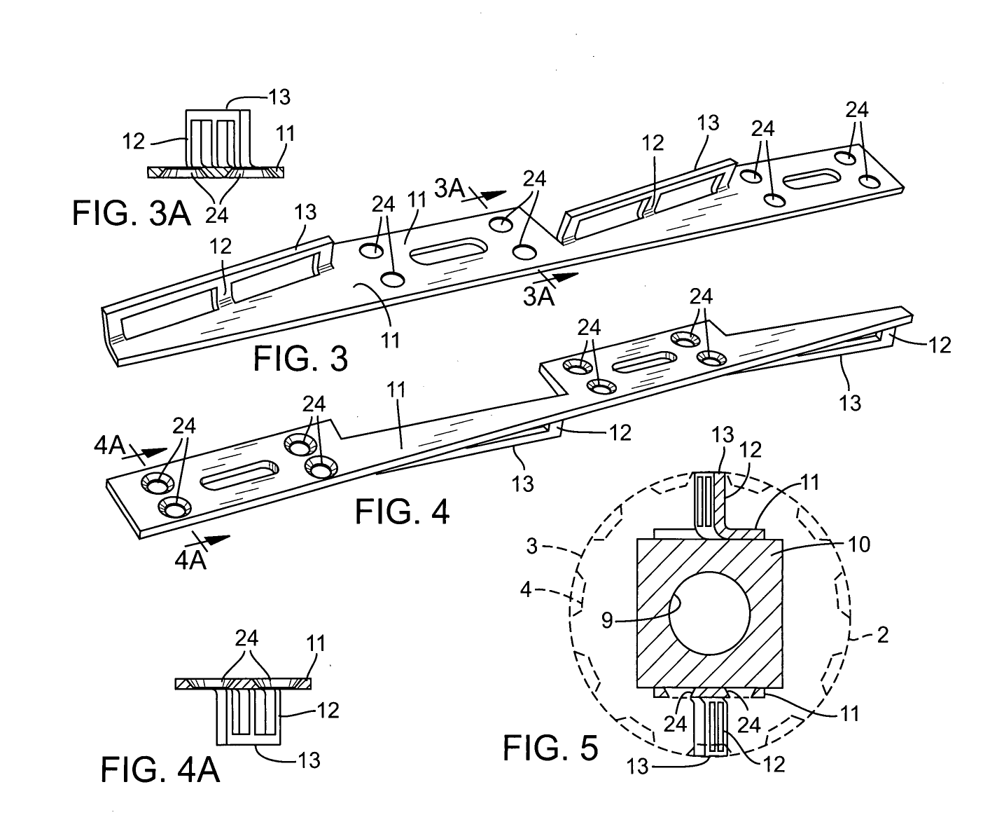

The plates 11 are provided with apertures or ports 24 countersunk to contribute to plate retention on the roll interior by the roll elastomer. FIGS. 3A and 4A best illustrate this feature.

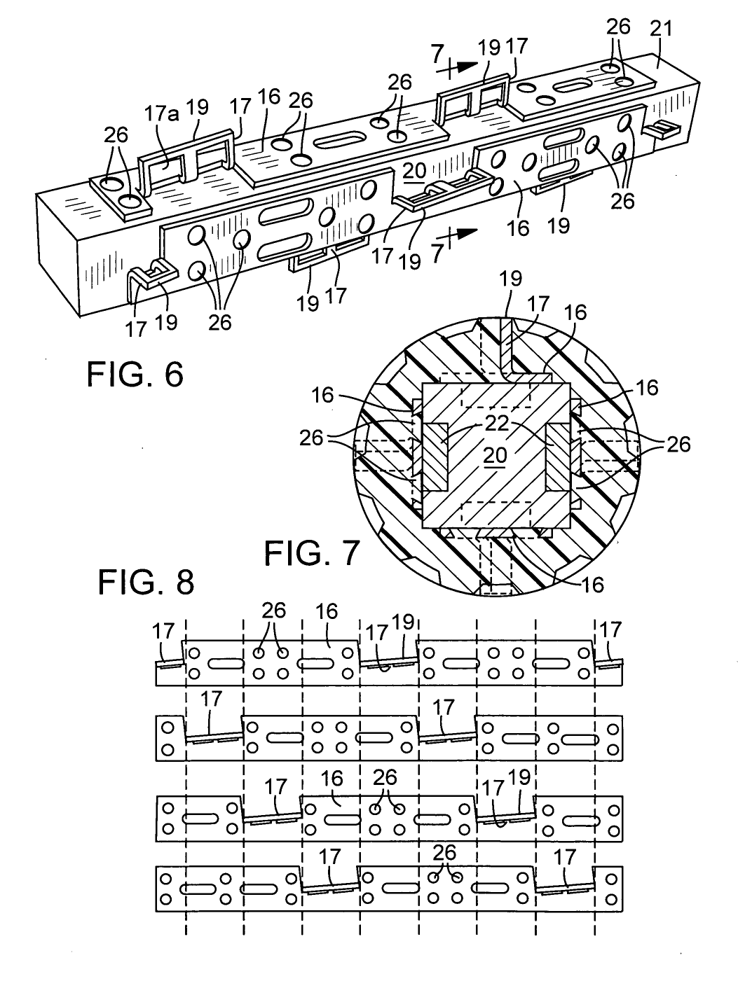

Modified drive means at 16 in FIG. 6 are shown as plates with blades 17 each having a cutting edge 19. The drive plates jointly define a polygonal lengthwise opening in the roll. Plate ports or openings at 26, and at 24 in the preferred form, accept an elastomer during molding of the roll for plate retention as do other blade open areas as in 17a.

Roll construction utilizes a mold loading device or bar 20 which serves to carry drive means 11 or 16 positioned thereon and retained in place by magnets 22 (FIG. 9) recessed in bar 20 in a fixed manor. End segments 21 of loading device 20 extend beyond the drive plates for reception in channels at the ends of a two piece roll mold.

Upon curing, the mold is opened, the roll removed followed by manual axial extraction of the loading device 20 from the finished roll.

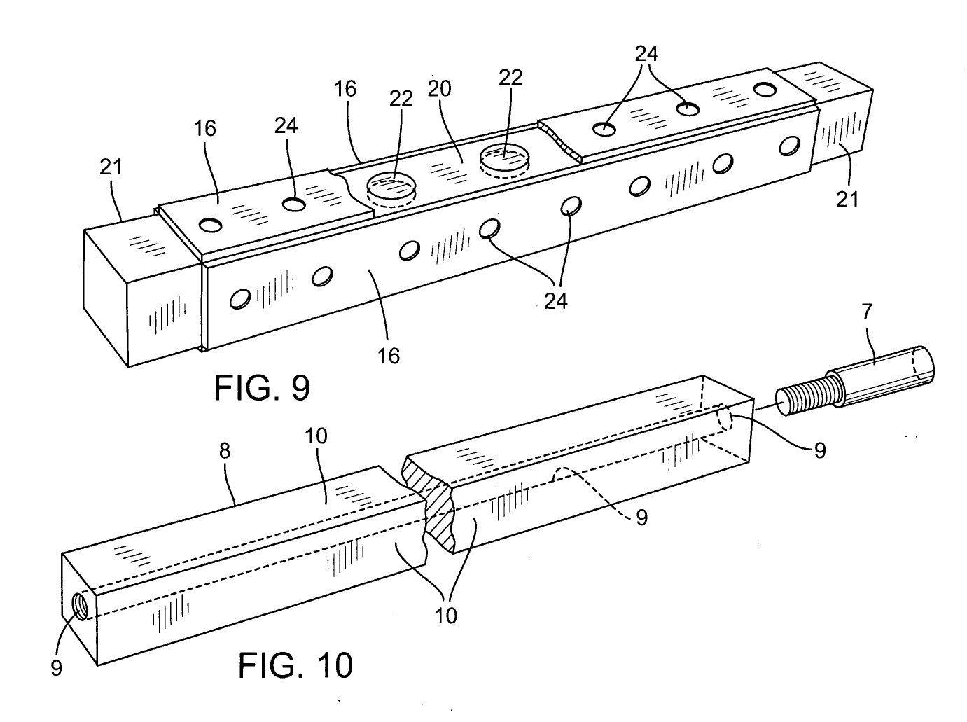

FIG. 8 shows, schematically, the path of each blade of a drive plate 16 to fully expose an article, such as an ear of corn, to blade action. The blade paths would be helical as the food product is in motion along the bite of cooperating rolls on adjacent powered shafts. Any upright product, such as an ear of corn, is transversely severed to avoid abrading grooves in a pair of cooperating rolls. Discharge of debris such as vines from a product is facilitated by blade action.

In the processing of some articles the roll carried drive plates may be without blades, as seen in FIG. 9 as when the roll cover 2 is of high density to exert sufficient force to extract matter from the articles being processed.

While I shown and described a few forms of the invention, it will be apparent to those skilled in the art that the invention may be embodied still otherwise without departing from the spirit and scope of the claimed invention.

Having thus described the invention, what is desired to be secured by a Letters Patent is:

I claim:

1. In a food processing machine an elongate molded roll having a lengthwise axial opening enabling installation on a powered shaft and having external lands for removal of debris from an article of food, the improvement comprising,
roll drive means at least partially defining the lengthwise axial opening and having planar surfaces for driven engagement with the powered shaft.

2. The improvements claimed in claim 1 wherein said planar surfaces form said lengthwise opening of polygonal section.

3. The improvement claimed in claim 2 wherein said drive means include plates.

4. The improvement claimed in claim 3 wherein said plates are elongate and coextensive with the roll.

5. The improvement claim in claim 4 wherein said plates define openings for reception of a mold elastomer.

6. The improvement claimed in claim 3 wherein said plates include blades.

7. The improvement claimed in claim 6 wherein said blades are embedded in said lands of the roll.

8. The improvement claimed in claim 7 wherein said blades have a helical component.

9. In combination,
a drive shaft of polygonal section, and
an elongate elastomeric roll on said drive shaft and having an axial opening there through occupied by said drive shaft and plates at least partially defining the opening in surfacial engagement with the shaft.

10. The combination claimed in claim 9 wherein said plates carry blades disposed normally thereon.

11. The combination claimed in claim 10 wherein said blades have a helical component.
